(19) United States
(12) Patent Application Publication
(10) Pub. No.: US 2016/0264443 A1
(43) Pub. Date: Sep. 15, 2016

(54) WATER RECOVERY METHOD AND SYSTEM

(71) Applicant: KURITA WATER INDUSTRIES LTD., Tokyo (JP)

(72) Inventors: Yukitaka MATSUMOTO, Tokyo (JP); Hideki KOBAYASHI, Tokyo (JP); Nobuhiro ORITA, Tokyo (JP)

(21) Appl. No.: 15/031,568

(22) PCT Filed: Nov. 22, 2013
(86) PCT No.: PCT/JP2013/081495

§ 371 Date: Apr. 22, 2016

(30) Foreign Application Priority Data
Oct. 24, 2013 (JP) 2013-221425

(51) Int. Cl. C02F 9/00; C02F 1/469; B01D 15/36; B01D 61/42; C02F 1/461; C02F 1/42; C02F 1/467

(52) U.S. Cl. CPC C02F 9/00; C02F 1/42; C02F 1/4693; C02F 1/4672; B01D 61/422; C02F 1/4618; B01D 15/362; C02F 2001/425; C02F 2201/4617; C02F 2201/4611; C02F 2303/16

(57) ABSTRACT

Wastewater such as water discharged by the human body and domestic wastewater which is produced in a confined space, can be treated and recovered with efficiency by using a simple apparatus. Specifically, hardness components of water-to-be-treated are removed with a softening apparatus. Subsequently, electrolysis is performed with a high-temperature high-pressure electrolysis apparatus in order to decompose and remove organic substances, urea, ammonia, and the like. The electrolyzed water is desalinated with a desalination electrodialysis apparatus in order to produce product water and a salt-concentrated liquid. The salt-concentrated liquid is further treated with an acid-alkali production electrodialysis apparatus in order to produce desalinated water, an acid solution, and an alkali solution. The acid solution is used as an agent for regenerating the softening apparatus. The alkali solution is used as an agent for converting the softening apparatus into Na-type. The desalinated water is treated with the desalination electrodialysis apparatus.

### FIELD OF INVENTION

The present invention relates to water recovery method and system in which wastewater containing scale components, organic substances, inorganic ions, and the like, that is, in particular, wastewater produced in confined spaces, such as water discharged by the human body and domestic wastewater, is treated and the treated water is recovered. Specifically, the present invention relates to a water recovery method by which wastewater produced in a confined space such as a nuclear shelter, a disaster evacuation center, a space station, a manned spacecraft for a lunar or Mars mission, or a lunar base can be treated inside the confined space by using a simple water recovery system with efficiency and to such a water recovery system.

### BACKGROUND OF INVENTION

When water discharged by the human body, such as urine, and domestic wastewater are produced in a confined space such as a nuclear shelter, a disaster evacuation center, a space station, a manned spacecraft for a lunar or Mars mission, or a lunar base and are treated and recovered inside the confined space, the following limitations apply:

(1) In structures in space and the like, where gravity is negligibly low, it is difficult to perform gas-liquid separation and solid-liquid separation by gravitation.

(2) In confined spaces, the types and amounts of emitted gases are limited.

(3) A high degree of water recovery is required. Moreover, power consumption and installation space need to be reduced.

Patent Literature 1 proposes a water recovery method in which membrane distillation is used. Membrane distillation has the following issues: waste to be treated may contain volatile components, and such waste cannot be removed by distillation or membrane distillation; evaporating wastewater containing hardness components may cause scaling; since the waste generally contains organic substances such as protein, fouling may be caused, which deteriorates the performance of membrane distillation; and membrane distillation consumes a large amount of energy since membrane distillation is fundamentally evaporation.

Patent Literature 2 proposes a water recovery method in which a membrane activated sludge process is conducted prior to membrane distillation. This method has, for example, the following issues: microorganisms are likely to be deactivated when the operating conditions are deviated from the proper values, and the deactivated microorganisms are not capable of being reactivated; and, in an activated sludge process, one third to half the organic substances are converted into sludge, that is, sludge containing precious water is disadvantageously disposed as waste.

Patent Literature 3 proposes a water recovery system including an apparatus that roughly removes hardness components, a softening apparatus, an electrolysis apparatus, a catalytic decomposition apparatus, and an electrodialysis apparatus.

The water recovery system proposed in Patent Literature 3 has the following issues: the electrolysis apparatus has a low current efficiency and consumes a large amount of power and needs to be further improved; in the electrolysis apparatus, an oxygen-hydrogen gas mixture is produced, and oxoacids of chlorine such as hypochlorous acid, chloric acid, and perchloric acid, which place loads on the electrodialysis apparatus disposed downstream of the electrolysis apparatus, are produced. Accordingly, means for treating the above substances needs to be provided; a catalytic decomposition apparatus needs to be disposed downstream of the electrolysis apparatus in order to treat organic substances that have not been completely removed by electrolysis performed with the electrolysis apparatus and oxidized substances produced by electrolysis, such as perchloric acid. Thus, the water recovery system is required to have a more simple structure with consideration of installation space, maintenance, and the like; and the degree of water recovery of the entire system may be reduced to a low level, because acids and alkalis are directly produced with the electrodialysis apparatus.

Patent Literature 4 describes a method in which water containing organic substances and reducing substances is treated by electrolysis in a high-temperature, high-pressure environment. However, Patent Literature 4 does not suggest the application of the treatment method to water recovery in confined spaces and decomposition of urea. Furthermore, no mention is made of issues that may arise when a system is constructed by employing the treatment method, such as impacts on the treatments performed upstream and downstream of the electrolysis apparatus which may occur in the case where water recovery is performed inside a confined space.

### LIST OF PATENT LITERATURE

Patent Literature 1: Japanese Patent Publication 2006-095526 A

Patent Literature 2: Japanese Patent Publication 2010-119963 A

Patent Literature 3: Japanese Patent Publication 2013-075259 A

Patent Literature 4: Japanese Patent 3746300 B

### SUMMARY OF INVENTION

An object of the present invention is to address the above-described issues found in the related art and to provide a water recovery method by which wastewater containing scale components, organic substances, inorganic ions, and the like, that is, in particular, wastewater such as water discharged by the human body and domestic wastewater which is produced in confined spaces such as a nuclear shelter, a disaster evacuation center, a space station, a manned spacecraft for a lunar or Mars mission, and a lunar base, can be treated by using a simple water recovery system with efficiency without concerns about clogging due to scaling, fouling due to organic substances, and the like or consuming a large amount of energy as in evaporation. Another object of the present invention is to provide such a water recovery system.

In order to address the above-described issues, the inventors of the present invention conducted extensive studies and, as a result, found that the issues may be addressed by treating wastewater such as domestic water and water discharged by the human body which is produced in confined spaces such as a space station with a softening apparatus in order to remove hardness components to a sufficient degree, performing electrolysis in a high-temperature, high-pressure environment in order to decompose oxidizable substances such as organic substances and ammonia, and removing ions with an electrodialysis apparatus in order to produce product water and a salt-concentrated liquid, that is, by performing electrolysis in a high-temperature, high-pressure environment in order to decompose the oxidizable substances contained in the wastewater, such as organic substances, urea, and ammonia, due to the following mechanisms.

Performing electrolysis in a high-temperature, high-pressure environment enables the oxidizable substances contained in the wastewater to be converted into carbonate ions, organic acid ions, nitrate ions, and the like which can be directly removed with the electrodialysis apparatus disposed downstream of the electrolysis apparatus.

By the electrolysis treatment performed in a high-temperature, high-pressure environment, part of the organic substances contained in the wastewater is decomposed into a carbonic acid gas and part of ammonia and nitric acid is decomposed into a nitrogen gas. This eliminates the need to dispose the catalytic decomposition apparatus downstream of the electrolysis apparatus as in Patent Literature 3. Furthermore, in a high-pressure environment, the gases generated by electrolysis dissolve in water under the action of the pressure. This reduces the likelihood of bubbles inhibiting matter that is to be decomposed from coming into contact with the surfaces of electrodes. In addition, performing the treatment at a high temperature makes it possible to utilize the effect of thermal decomposition and increases mass transfer rate. This increases the efficiency of electrolysis and causes a reaction in which hydrogen and oxygen gases produced by the electrolysis of water are recombined into water. This reduces the oxygen concentration in the highly explosive hydrogen-oxygen gas mixture, improves the safety of the by-product gas by reducing the concentration of the by-product gas to be lower than the explosion limit, and increases the degree of water recovery. Furthermore, the amount of oxides produced by electrolysis can be reduced. This reduces the amount of load placed on the electrodialysis apparatus disposed downstream of the electrolysis apparatus.

The electrolyzed water is treated with a desalination electrodialysis apparatus in order to remove organic acid ions and nitrate ions, which are produced by partial decomposition of organic substances and ammonia due to electrolysis performed in a high-temperature, high-pressure environment, residual ammonia, other inorganic ions, and the like prior to the production of acids and alkalis. As a result, product water and a high-concentration salt-concentrated liquid are produced separately. This increases the efficiency of the recovery of product water.

The present invention is made on the basis of the above-described findings. The summary of the present invention is as follows.

[1] A water recovery method in which wastewater is treated and the resulting treated water is recovered as product water, the water recovery method comprising: a softening step in which the wastewater is treated with a softening apparatus in order to remove a hardness component of the wastewater; a high-temperature high-pressure electrolysis step in which softened water produced in the softening step is electrolyzed with a high-temperature high-pressure electrolysis apparatus, the electrolysis apparatus applying a direct current at a temperature equal to or higher than 100° C. and equal to or lower than a critical temperature of the softened water under a pressure at which the softened water is in a liquid phase in order to decompose an oxidizable substance contained in the softened water; and a desalination electrodialysis step in which electrolyzed water produced in the high-temperature high-pressure electrolysis step is treated with an electrodialysis apparatus in order to produce product water and a salt-concentrated liquid, the product water including desalinated water being the electrolyzed water from which ions have been removed.

[2] The water recovery method according to [1], wherein the wastewater is generated in a confined space.

[3] The water recovery method according to [1] or [2], wherein the electrolyzed water is fed from the high-temperature high-pressure electrolysis step to the desalination electrodialysis step without any other water treatment step conducted therebetween.

[4] The water recovery method according to any one of [1] to [3], wherein, in the high-temperature high-pressure electrolysis step, electrolysis is performed with a high-temperature high-pressure electrolysis apparatus including a conductive diamond electrode in a high-temperature high-pressure environment of 200° C. or more and 5 MPa or more.

[5] The water recovery method according to any one of [1] to [4], wherein the high-temperature high-pressure electrolysis apparatus includes a cylindrical, tubular container and an anode, the anode being disposed inside the container so as to extend in a direction in which water-to-be-treated flows and to be insulated from the container, the container serving as a cathode in electrolysis.

[6] The water recovery method according to any one of [1] to [5], wherein the softened water is passed through the high-temperature high-pressure electrolysis apparatus in a once-through manner.

[7] The water recovery method according to any one of [1] to [6], wherein the high-temperature high-pressure electrolysis apparatus includes one or more reaction container groups arranged in parallel, the reaction container groups each being constituted by a plurality of reaction containers connected to one another in series.

[8] The water recovery method according to any one of [1] to [7], wherein the pressure inside the high-temperature high-pressure electrolysis apparatus is increased by controlling a high-pressure pump disposed on an entry side of the electrolysis apparatus, the high-pressure pump feeding water-to-be-treated to the electrolysis apparatus, and a back-pressure valve disposed on an exit side of the electrolysis apparatus.

[9] The water recovery method according to any one of [1] to [8], further comprising a heat exchanging step in which the softened water passed into the high-temperature high-pressure electrolysis apparatus is heated by exchanging heat between the softened water and the electrolyzed water in a high-pressure environment.

[10] The water recovery method according to any one [1] to [9], further comprising an acid-alkali production electrodialysis step in which the salt-concentrated liquid produced in the desalination electrodialysis step is further treated with an electrodialysis apparatus in order to produce desalinated water, an acid solution, and an alkali solution; and a regeneration step in which the softening apparatus is regenerated by using the acid solution and the alkali solution produced in the acid-alkali production electrodialysis step.

[11] The water recovery method according to [10], wherein part or the entirety of the desalinated water produced in the acid-alkali production electrodialysis step is treated in the desalination electrodialysis step together with the electrolyzed water.

[12] A water recovery system in which wastewater is treated and the resulting treated water is recovered as product water, the water recovery system comprising: a softening apparatus that removes a hardness component of the wastewater; a high-temperature high-pressure electrolysis apparatus that electrolyzes softened water produced by the softening apparatus by applying a direct current at a temperature equal to or higher than 100° C. and equal to or lower than a critical temperature of the softened water under a pressure at which the softened water is in a liquid phase in order to decompose an oxidizable substance contained in the softened water; and a desalination electrodialysis apparatus that treats electrolyzed water produced with the high-temperature high-pressure electrolysis apparatus in order to produce product water and a salt-concentrated liquid, the product water including desalinated water being the electrolyzed water from which ions have been removed.

[13] The water recovery system according to [12], wherein the wastewater is generated in a confined space.

[14] The water recovery system according to [12] or [13], wherein the electrolyzed water is fed from the high-temperature high-pressure electrolysis apparatus to the desalination electrodialysis apparatus without any other water treatment means interposed therebetween.

[15] The water recovery system according to any one of [12] to [14], wherein the high-temperature high-pressure electrolysis apparatus includes a conductive diamond electrode and performs electrolysis in a high-temperature high-pressure environment of 200° C. or more and 5 MPa or more.

[16] The water recovery system according to any one of [12] to [15], wherein the high-temperature high-pressure electrolysis apparatus includes a cylindrical, tubular container and an anode, the anode being disposed inside the container so as to extend in a direction in which water-to-be-treated flows and to be insulated from the container, the container serving as a cathode in electrolysis.

[17] The water recovery system according to any one of [12] to [16], wherein the softened water is passed through the high-temperature high-pressure electrolysis apparatus in a once-through manner.

[18] The water recovery system according to any one of [12] to [17], wherein the high-temperature high-pressure electrolysis apparatus includes one or more reaction container groups arranged in parallel, the reaction container groups each being constituted by a plurality of reaction containers connected to one another in series.

[19] The water recovery system according to any one of [12] to [18], wherein the pressure inside the high-temperature high-pressure electrolysis apparatus is increased by controlling a high-pressure pump disposed on an entry side of the electrolysis apparatus, the high-pressure pump feeding water-to-be-treated to the electrolysis apparatus, and a back-pressure valve disposed on an exit side of the electrolysis apparatus.

[20] The water recovery system according to any one of [12] to [19], further comprising a heat exchanger that heats the softened water passed into the high-temperature high-pressure electrolysis apparatus by exchanging heat between the softened water and the electrolyzed water in a high-pressure environment.

[21] The water recovery system according to any one of [12] to [20], further comprising an acid-alkali production electrodialysis apparatus that treats the salt-concentrated liquid produced by the desalination electrodialysis apparatus in order to produce desalinated water, an acid solution, and an alkali solution; and pipes through which the acid solution and the alkali solution produced with the acid-alkali production electrodialysis apparatus are each fed to the softening apparatus, the acid solution and the alkali solution being used for regenerating the softening apparatus.

[22] The water recovery system according to [21], further comprising means for returning part or the entirety of the desalinated water produced by the acid-alkali production electrodialysis apparatus is returned to an entry side of the desalination electrodialysis apparatus.

### Advantageous Effects of Invention

According to the present invention, wastewater containing scale components, organic substances, inorganic ions, and the like can be treated by using a simple water recovery system with efficiency without concerns about clogging due to scaling, fouling due to organic substances, and the like or consuming a large amount of energy as in evaporation, and the treated water can be recovered and reused. This makes it possible to reuse water, which is vital to human life, in structures in space such as a space station or a spacecraft and enables humans to stay in the structures in space for a prolonged period of time.

### BRIEF DESCRIPTION OF DRAWINGS

FIG. 1 is a system diagram illustrating an example of a water recovery system according to an embodiment of the present invention.

FIG. 2 is a schematic cross-sectional view of a desalination electrodialysis apparatus used in the present invention, illustrating the migration of ions.

FIG. 3 is a schematic cross-sectional view of an acid-alkali production electrodialysis apparatus used in the present invention, illustrating the migration of ions.

FIG. 4 is a graph illustrating the results obtained in Test Example 1.

FIG. 5 is a graph illustrating the results obtained in Test Example 2.

### DESCRIPTION OF EMBODIMENTS

Water recovery method and system according to an embodiment of the present invention are described below in detail with reference to the attached drawings. However, the present invention is not limited by the following embodiment within the scope thereof.

Hereinafter, a case where the present invention is applied to water recovery method and system in which wastewater produced in a confined space is treated and the treated water is reused is mainly described as an example. However, the present invention may be applied to not only the treatment and recovery of wastewater produced in a confined space, but also the treatment and recovery of various types of wastewater containing scale components, organic substances, inorganic ions, and the like.

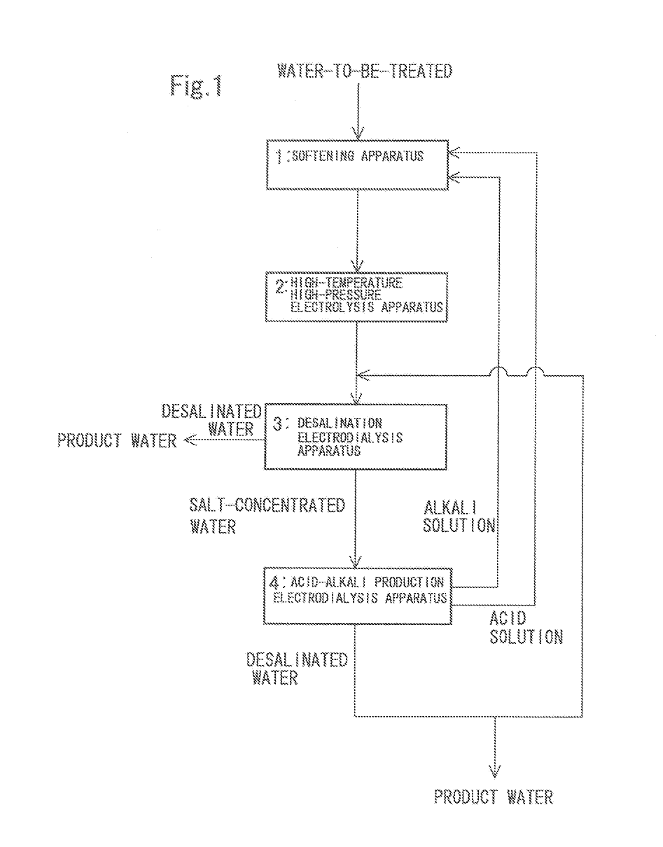

FIG. 1 is a system diagram illustrating an example of a water recovery system according to an embodiment of the present invention.

In the present invention, as illustrated in FIG. 1, wastewater containing scale components, organic substances, inorganic ions, and the like which is produced in a confined space or the like, which is the water-to-be-treated, is introduced to a softening apparatus 1 in order to remove hardness components of the wastewater. The softened water is electrolyzed with a high-temperature high-pressure electrolysis apparatus 2 in a high-temperature, high-pressure environment in order to decompose and remove oxidizable substances contained in the softened water. The electrolyzed water is treated with a desalination electrodialysis apparatus 3. Thus, product water and a salt-concentrated liquid are produced. The product water is desalinated water produced by removing ions from the electrolyzed water.

Preferably, the salt-concentrated liquid produced with the desalination electrodialysis apparatus 3 is further treated with an acid-alkali production electrodialysis apparatus 4 to produce desalinated water, an acid solution, and an alkali solution. The acid solution and the alkali solution are used for regenerating the softening apparatus 1. Part or the entirety of the desalinated water produced with the acid-alkali production electrodialysis apparatus 4 is returned to the entry side of the desalination electrodialysis apparatus 3 and subsequently treated with the desalination electrodialysis apparatus 3 together with the electrolyzed water passed from the high-temperature high-pressure electrolysis apparatus 2.

<Water-to-be-Treated>

The type of water that is to be treated in the present invention is wastewater containing scale components, organic substances, inorganic ions, and the like. Examples of such wastewater include water discharged by the human body and domestic wastewater which are produced in confined spaces such as a nuclear shelter, a disaster evacuation center, a space station, a manned spacecraft for a lunar or Mars mission, and a lunar base. In particular, the present invention may be suitably applied to confined spaces such as a survival shelter and to structures in space such as a space station and a spacecraft. The present invention may be particularly advantageously applied to structures in space.

Examples of the types of wastewater discharged from the above confined spaces mainly include condensed water produced by an air conditioner; and sweat and urine discharged by the human body. Thus, the wastewater contains scale components such as Mg and Ca, organic substances such as protein and urea, and inorganic ions of Na, K, Cl, SO₄, PO, NH₃, and NO, and the like.

Since urine and the various types of domestic wastewater that are produced in a confined space have different water qualities, in the water recovery performed in the present invention, the various types of wastewater may be each treated separately as needed. Alternatively, the various types of wastewater may be mixed with one another before being treated. In another case, it is also possible to merge a specific type of water-to-be-treated with treated water at a midpoint of the treatment process. It is desirable to select a suitable one from the above-described treatment methods with consideration of the efficiency of the treatment.

In general, among the various types of water-to-be-treated described above, urine contains the largest amount of scale components. Therefore, removal of hardness components performed with the softening apparatus 1 may be applicable for only urine, and the other types of water-to-be-treated may be merged and treated in the subsequent step, that is, in the high-temperature high-pressure electrolysis apparatus 2. This enables efficient treatment of the water-to-be-treated without redundantly increasing the amount of water-to-be-treated in each step.

<Water-Softening Treatment>

In the present invention, hardness components are firstly removed from the above-described wastewater produced in a confined space. In this water-softening treatment, a Na-type strongly acidic cation-exchange resin or weakly acidic cation-exchange resin may be used. Removal of the hardness components is achieved by the following ion-exchange reaction.

CaX,MgX+R—Na→R═Ca,R═Mg+NaX

where X represents an anion, and R represents an exchange group of the ion-exchange resin.

In general, as a softening apparatus 1, an ion-exchange resin column packed with a Na-type strongly acidic cation-exchange resin or weakly acidic cation-exchange resin is used. Although the treatment conditions are not limited, normally, the treatment temperature is set to 20° C. to 40° C., and the SV (space velocity) at which the water is passed through the apparatus is set to 5 to 20 hr⁻¹.

By the water-softening treatment, scale components of the water-to-be-treated, such as divalent Mg and Ca ions, are removed. This reduces the likelihood of scaling occurring in the high-temperature high-pressure electrolysis apparatus 2 disposed downstream of the softening apparatus 1 and increases the current efficiency.

<Electrolysis in High-Temperature, High-Pressure Environment>

The softened water, which is produced by removing the hardness components of the water-to-be-treated in the above water-softening treatment, is subsequently electrolyzed with the high-temperature high-pressure electrolysis apparatus 2 in order to decompose and remove oxidizable substances contained in the wastewater, such as organic substances, urea, and ammonia. Specifically, the concentration of the above oxidizable substances in the wastewater is about 100 to 20000 mg/L in terms of TOC. The concentration of the above oxidizable substances in urine is 1000 to 10000 mg/L and is generally about 5000 to 7000 mg/L.

A reaction container included in the high-temperature high-pressure electrolysis apparatus 2 is preferably as described below.

In a cylindrical container such as a pipe (cylindrical, tubular container) having an end serving as an inlet through which the water-to-be-treated enters and the other end serving as an outlet through which the electrolyzed water exits, an anode is disposed so as to be parallel to the direction in which the water-to-be-treated (the softened water) flows and to be separated from the container such that the anode is insulated from the container. The pipe serves as a cathode. A direct-current power source is connected between the anode and cathode. Since a cylindrical container is likely to have higher resistance to the internal pressure than containers having other shapes, such as a rectangular container, the thickness of the reaction container can be reduced. This enables the size of the apparatus to be reduced. Arranging the electrodes to be parallel to the direction in which the water-to-be-treated flows enables the generated bubbles to be washed away to the outside of the container together with the treated water. This reduces the likelihood of the bubbles adhering to the electrodes and increases the reaction efficiency.

The cathode of the high-temperature high-pressure electrolysis apparatus (i.e., the inner wall of the reaction container) may be composed of, for example, a nickel base alloy such as Hastelloy and Incoloy; a titanium base alloy; or a steel such as a carbon steel or a stainless steel. The cathode may optionally be coated with a metal such as platinum.

The cathode may include a conductive diamond electrode. A cathode including a conductive diamond electrode has high chemical stability and high current efficiency and is preferably used from the viewpoint of the efficiency of electrolysis. In such a case, the conductive diamond electrode may be prepared by depositing a conductive diamond coating layer on a base material composed of a metal such as niobium, tungsten, a stainless steel, molybdenum, platinum, or iridium.

The anode is preferably arranged such that the distance between the anode and the inner wall of the reaction container, which served as a cathode, is uniform. If the distance between the anode and the inner wall fluctuates, an excessively large amount of current may flow locally at a position at which the distance between the anode and the inner wall is small. This disadvantageously promotes the degradation of the portion of the anode. In the present invention, a tabular, solid cylindrical, or hollow cylindrical anode is preferably disposed in the cylindrical, tubular container such that the central axis of the anode substantially coincides with that of the inner wall of the reaction container.

As an anode, one or a plurality of tabular electrodes may be directly used. Alternatively, a mesh or a screen formed into a hollow cylindrical shape and a plate formed into a hollow cylindrical shape may also be used as an anode. In another case, the anode may have a rod-like shape.

At least the surface of the anode is preferably composed of ruthenium, iridium, platinum, palladium, rhodium, tin, an oxide of one selected from the above metals, or ferrite. The entirety of the anode may be composed of one selected from the above substances. In another case, the surface of the base metal of the anode may be coated with one selected from the above substances.

Ruthenium, iridium, platinum, palladium, rhodium, and tin that may be included in the anode may be used in the form of an element or an oxide. Alloys of the above metals may also be suitably used. Examples of such alloys include platinum-iridium, ruthenium-tin, and ruthenium-titanium. The above metals have high corrosion resistance and exhibit high insolubility when being used as an anode.

The anode may include a conductive diamond electrode for the same reason as in the cathode. In such a case, the entirety of the anode may be composed of conductive diamond. Alternatively, the anode may be prepared by coating a base material composed of a metal such as silicon, niobium, tungsten, a stainless steel, molybdenum, platinum, or iridium or a nonmetal such as silicon carbide, silicon nitride, molybdenum carbide, or tungsten carbide with a conductive diamond coating layer. Since the decomposition of TOC occurs particularly on the anode, using an anode including the conductive diamond electrode enables efficient decomposition of TOC.

The term “high-temperature, high-pressure environment” used herein refers to an environment of a temperature equal to or higher than 100° C. and equal to or lower than the critical temperature of the water-to-be-treated and a pressure at which the water-to-be-treated is in the liquid phase, which is normally an environment of 100° C. to 374° C. and 2 to 20 MPa and is preferably an environment of 200° C. to 250° C. and 5 to 10 MPa. In particular, performing electrolysis at 200° C. or more increases the efficiency of decomposition of protein and urea.

The conditions under which electrolysis is performed in a high-temperature, high-pressure environment vary depending on the qualities of the water-to-be-treated, the type of electrodes used, the structure of the reaction container used, and the like. The amount of the direct current supplied is normally about 2 to 30 A and is preferably about 5 to 20 A, the electric current density is normally 0.1 to 500 A/dm² and is preferably 1 to 50 A/dm², and the duration of electrolysis is normally 0.5 to 30 hr and is preferably 5 to 20 hr. Thus, in a once-through-type reaction container that electrolyzes the water-to-be-treated by passing the water through the cylindrical, tubular container from an end to the other end, the flow rate of the water-to-be-treated is preferably controlled such that the time during which the water-to-be-treated retains inside the reaction container falls within the above preferable range of the duration of electrolysis.

Specifically, the linear velocity of the water in the high-temperature high-pressure electrolysis apparatus is 0.1 to 50 m/hr and is preferably 1 to 20 m/hr. In the case where electrolysis is performed in a low-temperature, low-pressure environment, bubbles are likely to accumulate on the electrodes and the linear velocity of the water needs to be increased in order to remove the bubbles. On the other hand, in the case where electrolysis is performed in a high-temperature, high-pressure environment, the formation of bubbles is reduced and it is not necessary to increase the linear velocity of the water. This allows the size of the apparatus to be reduced.

In the above-described electrolysis performed in a high-temperature, high-pressure environment, organic substances, urea, ammonia, and the like are decomposed by the following reactions. Since electrolysis is performed in the above high-temperature, high-pressure environment in the present invention, generation of oxygen gas and hydrogen gas in electrolysis and generation of oxidized substances such as perchloric acid can be reduced. Furthermore, setting reaction conditions such that water is produced from oxygen and hydrogen increases the degree of water recovery.

Organic Substance→(Oxidation)→Organic Acid,CO₂

Urea→NH₄++CO₃²⁻

2NH₃₊₃HClO→N₂₊₃H₂O+3HCl

By using hypochlorous acid produced by the above reactions, organic substances such as protein and urea are decomposed into ions of organic acid, ammonia, and the like which can be removed with the desalination electrodialysis apparatus 3 disposed downstream of the electrolysis apparatus. Thus, in the present invention, urea, which cannot be removed with either the electrodialysis apparatus 3 disposed downstream of the electrolysis apparatus or the electroregenerative deionization apparatus described below, can be removed with the high-temperature high-pressure electrolysis apparatus 2 by being decomposed into ammonia and carbonic acid due to electrolysis performed in a high-temperature, high-pressure environment. Note that, in the above reaction formulae, HClO is generated by an electrolytic reaction (2Cl⁻+H₂O→HClO+HCl+2e⁻) of chlorine ions contained in the water-to-be-treated (wastewater).

While common electrolysis causes inorganic ions to be oxidized and perchloric acids such as ClO₃ and ClO₄ to be generated, in the present invention, where electrolysis is performed in a high-temperature, high-pressure environment, the generation of the above oxidized substances can be reduced. Furthermore, the generation of the perchloric acids such as ClO₃ and ClO₄, which place loads on the desalination electrodialysis apparatus 3 disposed downstream of the electrolysis apparatus, can also be reduced. This eliminates the need to dispose a catalytic decomposition apparatus for decomposing the perchloric acids and the like downstream of the high-temperature high-pressure electrolysis apparatus 2 as in Patent Literature 3 described above and enables the electrolyzed water to be directly fed to the desalination electrodialysis apparatus 3 without passing through any other water treatment means.

In the above-described electrolysis performed in a high-temperature, high-pressure environment, the amount of energy required to increase the temperature can be reduced by exchanging heat between the electrolyzed water and the water-to-be-treated in a high-pressure environment. Thus, it is preferable to provide a heat exchanger that exchanges heat between the softened water that enters the high-temperature high-pressure electrolysis apparatus 2 and the electrolyzed water that exits the high-temperature high-pressure electrolysis apparatus 2 while maintaining the high-pressure environment.

For increasing the pressure of the water-to-be-treated in the high-temperature high-pressure electrolysis apparatus 2, for example, pressurization may be performed using a gas. However, there are limitations on equipment, space, and the like inside a confined space. Therefore, pressurization may be performed using a pump so as to achieve a targeted pressure. This reduces the size of the apparatus and the space for the apparatus. In such a case, the pressure during electrolysis can be controlled by adjusting a high-pressure pump that increases the pressure of the water-to-be-treated in order to feed the water-to-be-treated to the high-temperature high-pressure electrolysis apparatus 2 and a back-pressure valve disposed at an outlet of the high-temperature high-pressure electrolysis apparatus 2 through which the treated water is discharged.

In the present invention, the high-temperature high-pressure electrolysis apparatus 2 is preferably an electrolysis apparatus that treats the water-to-be-treated by passing the water-to-be-treated therethrough in a once-through manner in order to reduce the equipment costs and power consumption compared with the case where a circulation-type electrolysis apparatus is used. Specifically, in the case where circulation is made while a high pressure is maintained, the circulation-type electrolysis apparatus needs to have a tank designed to endure high pressures. In the case where the pressure is released when circulation is made, it is necessary to increase the pressure repeatedly. This excessively increases the amount of power consumed by a water-feeding pump. On the other hand, a once-through-type electrolysis apparatus does not have the above issues. The high-temperature high-pressure electrolysis apparatus 2 may include a plurality of the above-described cylindrical, tubular reaction containers connected to one another in series. Alternatively, the high-temperature high-pressure electrolysis apparatus 2 may include a plurality of reaction container groups arranged in parallel, each of the reaction container groups including a plurality of the reaction containers connected to one another in series. Arranging a plurality of the reaction containers in the above manner increases the amount of water treated with the high-temperature high-pressure electrolysis apparatus 2 and the amounts of organic substances and the like decomposed. Optimizing the conditions under which a current is passed through each of the reaction containers on the basis of the concentration of the organic substances at the entrance of the reaction container enhances current efficiency, reduces the amount of the voltage applied, and reduces the amount of the power consumed.

<Desalination Treatment>

In the present invention, a catalytic decomposition apparatus as used in Patent Literature 3 is not provided, but a desalination electrodialysis apparatus 3 is disposed downstream of the high-temperature high-pressure electrolysis apparatus 2 instead. The desalination electrodialysis apparatus 3 removes ions from the electrolyzed water in order to produce the electrolyzed water into product water (desalination treated water) and a salt-concentrated liquid separately. This removes salts contained in the water-to-be-treated and ions of organic acids, a CO₂ gas, ammonia, nitric acid, and the like which are generated in the high-temperature high-pressure electrolysis apparatus 2 disposed upstream of the desalination electrodialysis apparatus 3.

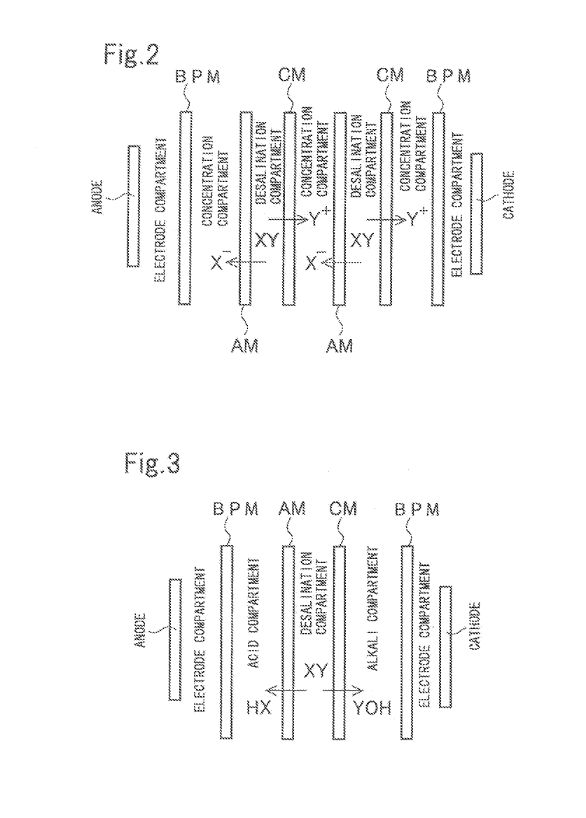

The desalination electrodialysis apparatus is a two-compartment electrodialysis apparatus including an anode; a cathode; at least one repeating unit constituted by a concentration compartment, an anion-exchange membrane AM, a desalination compartment, a cation-exchange membrane CM, and a concentration compartment; and an electrode compartment and a bipolar membrane BPM that are interposed between the anode and the repeating unit and between the cathode and the repeating unit such that the concentration compartments face the respective electrodes as illustrated in FIG. 2. In the desalination electrodialysis apparatus 3, anions X⁻ and cations Y⁺ constituting salts (XY) contained in the water-to-be-treated that passes through the desalination compartment permeate through the anion-exchange membrane AM and the cation-exchange membrane CM, respectively, and concentrate inside the respective concentration compartments. As a result, water that does not contain salts, that is, desalinated water, is produced from the desalination compartment, and a salt-concentrated liquid is produced from the concentration compartments. The water produced from the desalination compartment, that is, product water, may be directly used as drinking water. The salt-concentrated liquid produced from the concentration compartments is fed to the acid-alkali production electrodialysis apparatus 4 disposed downstream of the desalination electrodialysis apparatus 3. This makes it possible to utilize the constituents of the water-to-be-treated in an effective manner. The water-to-be-treated (the electrolyzed water) fed to the desalination electrodialysis apparatus has an electric conductivity of 1000 to 5000 mS/m and particularly has an electric conductivity of 2000 to 3000 mS/m. The water quality acceptable for product water produced by desalination is an electric conductivity of 100 mS/m or less, is preferably an electric conductivity of 10 mS/m or less, and is more preferably an electric conductivity of 5 mS/m or less.

Although the conditions under which electrodialysis is performed in the desalination electrodialysis apparatus 3 described above are not limited, the treatment is preferably performed under the following conditions: a temperature of 20° C. to 40° C., a pressure of 0 to 0.1 MPa, a linear velocity of about 1 to 100 m/hr, a flow rate of about 1 to 100 mL/min, which varies depending on the size of the apparatus.

Similarly to the high-temperature high-pressure electrolysis apparatus 2, the desalination electrodialysis apparatus 3 is preferably an apparatus that treats the water by passing the water therethrough in an once-through manner in order to reduce the amount of the power consumed compared with a circulation-type desalination electrodialysis apparatus while maintaining a certain degree of water recovery.

<Production of Acid and Alkali>

In the present invention, an acid-alkali production electrodialysis apparatus 4 that produces an acid solution and an alkali solution from the salt-concentrated liquid discharged from the concentration compartments of the desalination electrodialysis apparatus 3 may optionally be provided. The acid-alkali production electrodialysis apparatus 4 is a three-compartment electrodialysis apparatus, which includes an anode; a cathode; at least one repeating unit constituted by an acid compartment, an anion-exchange membrane AM, a desalination compartment, a cation-exchange membrane CM, and an alkali compartment; and an electrode compartment and a bipolar membrane BPM that are interposed between the anode and the repeating unit and between the cathode and the repeating unit such that the acid compartment faces the anode and the alkali compartment faces the cathode as illustrated in FIG. 3. As illustrated in FIG. 3, anions X⁻ and cations Y⁺ contained in the water-to-be-treated permeate through the anion membrane AM and the cation membrane CM, respectively, and migrate to the acid compartment and the alkali compartment, respectively. As a result, desalinated water is produced from the desalination compartment, an acid solution is produced from the acid compartment, and an alkali solution is produced from the alkali compartment. That is, the structure of the acid-alkali production electrodialysis apparatus 4 differs from that of the desalination electrodialysis apparatus 3 in that the compartments adjacent to the desalination compartment are not concentration compartments in which anions X⁻ or cations Y⁺ are concentrated but an acid compartment in which only anions are concentrated and H⁺ ions are generated in water and an alkali compartment in which only cations are concentrated and OH⁻ ions are generated in water.

Part of the desalinated water produced from the acid-alkali production electrodialysis apparatus 4 may be recovered as product water. Part or the entirety of the desalinated water may be returned to the entry side of the desalination electrodialysis apparatus 3 disposed upstream of the acid-alkali production electrodialysis apparatus 4 and desalinated together with the electrolyzed water. This increases the degree of water recovery.

In the case where part or the entirety of the desalinated water is returned to the entry side of the desalination electrodialysis apparatus 3 disposed upstream of the acid-alkali production electrodialysis apparatus 4, the treatment is performed such that the desalinated water produced with the acid-alkali production electrodialysis apparatus 4 has substantially the same qualities as the electrolyzed water.

The acid solution and alkali solution produced with the acid-alkali production electrodialysis apparatus 4 may be used for regenerating the softening apparatus 1 disposed upstream of the acid-alkali production electrodialysis apparatus 4. Specifically, the acid solution may be used as an agent for regenerating the Na-type strongly acidic cation-exchange resin or weakly acidic cation-exchange resin included in the softening apparatus 1, and the alkali solution may be used as an agent for converting the strongly acidic cation-exchange resin or weakly acidic cation-exchange resin into a Na-type cation-exchange resin.

Although the conditions under which the above-described electrodialysis is performed with the acid-alkali production electrodialysis apparatus 4 are not limited, it is preferable to perform electrodialysis under the following conditions: a temperature of 20° C. to 40° C., a pressure of 0 to 0.1 MPa, a flow rate of about 50 to 100 m/hr, and a flow rate of about 1 to 100 mL/min, which varies depending on the size of the apparatus.

Similarly to the high-temperature high-pressure electrolysis apparatus 2, the acid-alkali production electrodialysis apparatus 4 may be an apparatus that treats the water by passing the water therethrough in a once-through manner. However, employing a circulation-type electrodialysis apparatus may increase the degree of recovery of acids and alkalis.

In the present invention, as described above, the amount of oxoacids of chlorine, which place a load on the electrodialysis apparatus, can be markedly reduced by performing electrolysis in a high-temperature, high-pressure environment. Performing electrodialysis in two steps with the electrodialysis apparatus 3 for desalination and the electrodialysis apparatus 4 for acid-alkali production markedly reduces the concentration of inorganic ions and enables clarified desalinated water to be produced from the former desalination electrodialysis apparatus 3 as product water. Specifically, the concentration of the aqueous solution (the concentrated liquid) adjacent to the product water (the desalinated water) across the membrane differs between the case where electrodialysis is performed in one step with one electrodialysis apparatus and the case where electrodialysis is performed in two steps with two electrodialysis apparatuses. In the case where electrodialysis is performed in one step, an attempt is made to remove the salts to a high degree with one electrodialysis apparatus and, as a result, an acid solution and an alkali solution having a high concentration are produced. On the other hand, in the case where electrodialysis is performed in two steps, the latter electrodialysis apparatus also removes the ions and, as a result, a concentrated liquid having a relatively low concentration is produced. Therefore, in the case where electrodialysis is performed in two steps, the difference in concentration between the desalinated water contained in the desalination compartment and the concentrated liquid contained in the concentration compartment, which is disposed adjacent to the desalination compartment across the membrane, is small. This enables clarified product water to be produced.

Although the product water produced with the desalination electrodialysis apparatus 3 is clarified enough without any treatment, the product water may optionally be treated with a reverse osmosis membrane or an electroregenerative deionization apparatus in order to further improve the qualities thereof. In such a case, the concentrated liquid discharged by the treatment performed with the reverse-osmosis-membrane separator or the electroregenerative deionization apparatus may be returned to the entry side of the desalination electrodialysis apparatus 3 and recycled.

The term “circulation-type” apparatus used herein refers to an apparatus in which the effluent of the apparatus is returned to the entry side of the apparatus and retreated with the apparatus. The term “once-through-type” apparatus used herein refers to an apparatus in which the effluent of the apparatus is directly fed to another apparatus disposed downstream of the apparatus without returning to the apparatus or a portion upstream of the apparatus. In any of the above types of apparatuses, a tank may optionally be interposed between the apparatuses, and the water may be fed through a pipe.

### EXAMPLES

The present invention is described more specifically below with reference to Test Examples, Examples, and Comparative Examples. In Examples and Comparative Examples, a tank was interposed between each pair of the adjacent apparatuses. In the case where circulation was made, water was circulated through the tanks disposed upstream of the respective apparatuses.

### Test Example 1

Water-to-be-treated, which was synthetic wastewater containing organic substances such as urea, protein, saccharides, and the like at a TOC concentration of 6500 mg/L, was electrolyzed with an electrolysis apparatus having the following specification in a batch-circulation manner in a high-temperature, high-pressure environment of 250° C. and 7 MPa and in a low-temperature, normal-pressure environment of 70° C. and atmospheric pressure. The amount of current was set to 1.2 A.

<Electrolysis Apparatus>

Reaction container: Cylindrical, tubular reaction container (inner diameter: 8 mm, length: 140 mm) having an end serving as an inlet through which the water-to-be-treated entered and the other end serving as an outlet through which the treated water exited.

Anode: Tabular conductive diamond electrode having a width of 6 mm and a length of 120 mm, which was coaxially arranged at the center of the reaction container.

Cathode: Conductive titanium pipe, which also served as the inner wall of the reaction container.

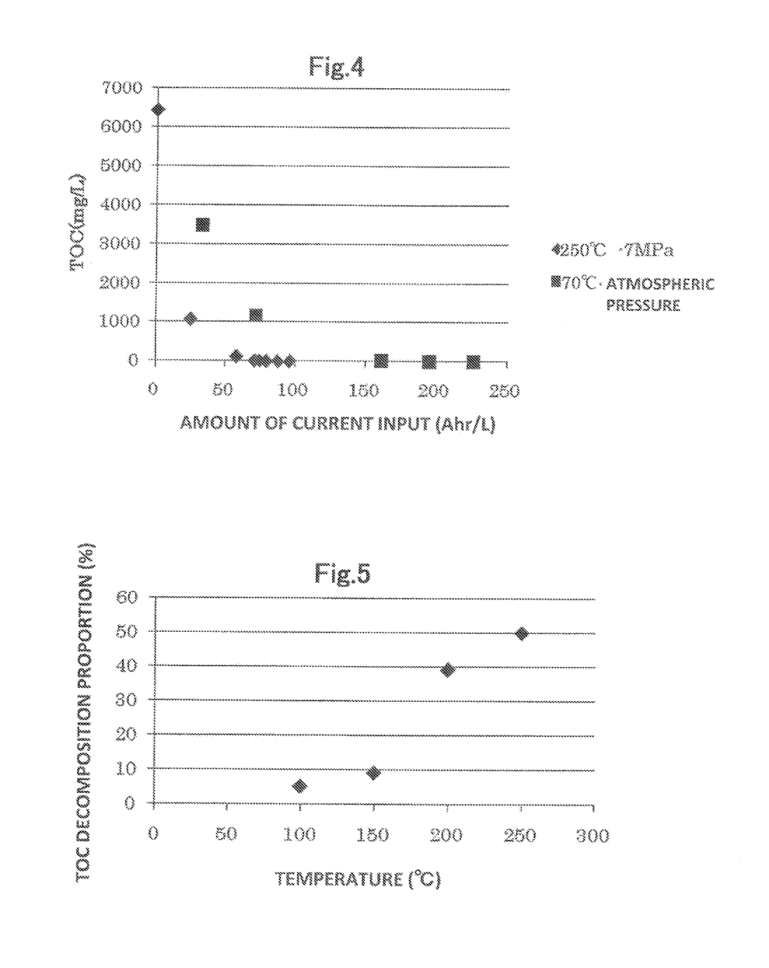

During electrolysis, a sample water was taken from the electrolyzed water contained in the reaction container at predetermined times, and the TOC concentration in the sample water was determined. FIG. 4 illustrates the relationships between the amount of current input (amount of current input per liter of the water-to-be-treated) and the TOC concentration in the electrolyzed water which were determined under the respective electrolysis conditions described above.

FIG. 4 shows that, even when the amounts of current input were the same, performing electrolysis in a high-temperature, high-pressure environment enabled TOC to be decomposed with sufficiency. It is preferable to reduce electric current density from the viewpoints of TOC decomposition proportion and power consumption because reducing electric current density increases the amount of TOC decomposed per unit amount of current and reduces the amount of voltage applied. On the other hand, from the viewpoint of a reduction in the size of the apparatus, it is preferable to increase electric current density. In the case where electrolysis is performed in a high-temperature, high-pressure environment, a certain TOC decomposition efficiency can be maintained even when electric current density is increased. This allows the size of the apparatus to be reduced.

### Test Example 2

Water-to-be-treated was electrolyzed as in Test Example 1, except that the pressure was maintained to be constant at 7 MPa during electrolysis, the electrolysis temperature was changed to 100° C., 150° C., 200° C., and 250° C., and electrolysis was performed for 1 hour (amount of current input: 20 Ahr/L). The proportion of TOC decomposed by electrolysis was determined on the basis of the TOC concentration in the electrolyzed water. FIG. 5 illustrates the results.

FIG. 5 shows that the TOC decomposition proportion was increased with an increase in the temperature at which electrolysis was performed. In particular, the efficiency of decomposition was markedly high at 200° C. or more. Accordingly, it is considered that electrolysis is preferably performed in a high-temperature environment of 200° C. or more in order to decompose TOC components such as protein, urea, and the like contained in urine with efficiency.

### Example 1

Water-to-be-treated having the qualities described in Table 1-1 was treated with the water recovery system illustrated in FIG. 1. The specifications of the apparatuses and treatment conditions were as follows.

<Softening Apparatus>

Na-type strongly acidic cation-exchange resin column

Temperature: 25° C.

SV at which the water was passed through the apparatus: 10 hr⁻¹

### <High-Temperature High-Pressure Electrolysis Apparatus>

The same as that used in Test Example 1 (note that, the treatment was performed by continuously passing the water through the apparatus in a once-through manner)

Temperature: 250° C.

Pressure: 7 MPa

Electric current density: 10 A/dm²

Linear velocity at which the water was passed through the apparatus: 4 m/hr

### <Desalination Electrodialysis Apparatus>

A once-through-type desalination electrodialysis apparatus having the structure illustrated in FIG. 2

Temperature: Room temperature

Pressure: 0.1 MPa

Electric current density: 1 A/dm²

Flow rate: 2.5 mL/min

### <Acid-Alkali Production Electrodialysis Apparatus>

A circulation-type acid-alkali production electrodialysis apparatus having the structure illustrated in FIG. 3

Temperature: Room temperature

Pressure: 0.1 MPa

Electric current density: 1 A/dm²

Flow rate: 50 mL/min

Concentrated liquid: The whole amount of the acid solution produced in the acid compartment was returned to the entry side of the acid compartment. The whole amount of the alkali solution

produced in the alkali compartment was returned to the entry side of the alkali compartment.

Desalinated water: The whole amount of desalinated water was returned to the desalination electrodialysis apparatus.

The qualities of the softened water, the high-temperature high-pressure electrolyzed water, and the product water (desalinated water produced with the desalination electrodialysis apparatus) were determined. Table 1-1 summarizes the results.

Table 3 summarizes power consumption (the amount of power consumed by the system when the amount of water-to-be-treated was 9 L/day) and water recovery (proportion of the amount of product water to the amount of water-to-be-treated). The above treatment was performed such that the electrolyzed water had a TOC concentration of 1 mg/L or less, the product water had an electric conductivity of 2 mS/m or less, and the desalinated water (water treated with the acid-alkali production electrodialysis apparatus) had an electric conductivity of 2000 mS/m or less.

### Example 2

Water-to-be-treated having the qualities described in Table 1-2 was treated as in Example 1, except that the high-temperature high-pressure electrolysis apparatus and the desalination electrodialysis apparatus were each changed to a circulation-type apparatus; in the high-temperature high-pressure electrolysis apparatus, circulation was made until the TOC concentration in the electrolyzed water reached a predetermined value (1 mg/L) or less; and, in the desalination electrodialysis apparatus, circulation was made until the quality of the product water reached a predetermined value (2 mS/m) or less.

The qualities of the softened water, the high-temperature high-pressure electrolyzed water, and the product water (water desalinated with the desalination electrodialysis apparatus) were determined. Table 1-2 summarizes the results. Table 3 summarizes the amount of power consumed and water recovery (proportion of the amount of product water to the amount of water-to-be-treated).

TABLE 1

| | TOC | Inorganic ions (mg/L) | | | | | | | | | | Free chlorine |
|---|---|---|---|---|---|---|---|---|---|---|---|---|
| pH | (mg/L) | Na | NH₄ | K | Mg | Ca | Cl | NO₃ | SO₄ | PO₄ | ClO₄ | (mg/L) |

<Table 1-1: Example 1>

| | | | | | | | | | | | | | |
|---|---|---|---|---|---|---|---|---|---|---|---|---|---|
| Water-to-be-treated | 6.7 | 6104 | 3327 | 1201 | 1862 | 68 | 265 | 5895 | 13 | 1630 | 1421 | <0.0.4 | 0 |
| Softened water | 9.2 | 5987 | 4252 | 1229 | 1776 | <0.1 | <0.1 | 6017 | 11 | 1645 | 1450 | <0.0.4 | 0 |
| High-temperature | 8.8 | <1 | 4304 | 40 | 1689 | <0.1 | <0.1 | 4958 | 230 | 1672 | 1317 | 353 | 0 |
| high-pressure | | | | | | | | | | | | | |
| electrolyzed water | | | | | | | | | | | | | |
| Product water | 7.2 | <1 | 2.3 | <0.1 | 0.22 | <0.1 | <0.1 | 2.3 | <0.1 | <1 | 4.4 | <0.0.4 | 0 |

<Table 1-2: Example 2>

| | | | | | | | | | | | | | |
|---|---|---|---|---|---|---|---|---|---|---|---|---|---|
| Water-to-be-treated | 6.7 | 6104 | 3327 | 1201 | 1862 | 68 | 265 | 5895 | 13 | 1630 | 1421 | <0.0.4 | 0 |
| Softened water | 9.2 | 5987 | 4252 | 1229 | 1776 | <0.1 | <0.1 | 6017 | 11 | 1645 | 1450 | <0.0.4 | 0 |
| High-temperature | 8.9 | <1 | 4401 | 38 | 1700 | <0.1 | <0.1 | 5072 | 245 | 1632 | 1445 | 344 | 0 |
| high-pressure | | | | | | | | | | | | | |
| electrolyzed water | | | | | | | | | | | | | |
| Product water | 7.1 | <1 | 29 | 0.4 | 8.3 | <0.1 | <0.1 | 15 | 1.5 | 19 | 21 | <0.0.4 | 0 |

### Comparative Example 1

Water-to-be-treated having the qualities described in Table 2-1 was treated with the water recovery system described in Patent Literature 3, which was constituted by a softening apparatus, an electrolysis apparatus, a catalytic decomposition apparatus, and an acid-alkali production electrodialysis apparatus that were arranged in this order. The specifications of the apparatuses and the treatment conditions were as follows.

<Softening Apparatus>

Na-type strongly acidic cation-exchange resin column

Temperature: 25° C.

SV at which the water was passed through the apparatus: 10 hr⁻¹

### <Electrolysis Apparatus>

The same as that used in Test Example 1 (note that the treatment was performed by continuously passing the water through the apparatus in a once-through manner)

Temperature: 70° C.

Pressure: 0.1 MPa

Electric current density: 2 A/dm²

Linear velocity at which the water was passed through the apparatus: 10 m/hr

### <Catalytic Decomposition Apparatus>

Catalytic decomposition apparatus including a Pt catalyst

Temperature: Room temperature

SV at which the water was passed through the apparatus: 10 hr⁻¹

### <Acid-Alkali Production Electrodialysis Apparatus>

A circulation-type acid-alkali production electrodialysis apparatus having the structure illustrated in FIG. 3

Temperature: Room temperature

Pressure: 0.1 MPa

Electric current density: 1 A/dm²

Flow rate: 50 mL/min

Desalinated water: Circulation was made

until the quality of the product water, that is, the desalinated water, reached a predetermined value (2 mS/m) or less.

The qualities of the softened water, the electrolyzed water, the catalytically decomposed water, and the product water (water desalinated with the acid-alkali production electrodialysis apparatus) were determined. Table 2-1 summarizes the results.

Table 3 summarizes the amount of power consumed and water recovery (proportion of the amount of product water to the amount of water-to-be-treated). The above treatment was performed such that the electrolyzed water had a TOC concentration of 1 mg/L or less and the product water had an electric conductivity of 2 mS/m or less.

### Comparative Example 2

Water-to-be-treated having the qualities described in Table 2-2 was treated as in Comparative Example 1, except that the electrolysis apparatus used in Comparative Example 1 was changed to a circulation-type electrolysis apparatus and, in the electrolysis apparatus, the linear velocity of the water was set to 150 m/hr and circulation was made until the TOC concentration in the electrolyzed water reached a predetermined value (1 mg/L) or less.

The qualities of the softened water, the electrolyzed water, the catalytically decomposed water, and the product water (water desalinated with the acid-alkali production electrodialysis apparatus) were determined. Table 2-2 summarizes the results. Table 3 summarizes the amount of consumed power and the degree of water recovery (proportion of the amount of product water to the amount of water-to-be-treated).

TABLE 2

| | TOC | Inorganic ions (mg/L) | | | | | | | | | | Free chlorine |
|---|---|---|---|---|---|---|---|---|---|---|---|---|
| pH | (mg/L) | Na | NH₄ | K | Mg | Ca | Cl | NO₃ | SO₄ | PO₄ | ClO₄ | (mg/L) |

<Table 2-1: Comparative Example 1>

| | | | | | | | | | | | | | |
|---|---|---|---|---|---|---|---|---|---|---|---|---|---|
| Water-to-be-treated | 6.7 | 6530 | 2731 | 1142 | 1931 | 101 | 272 | 6451 | 19 | 1429 | 2256 | <0.0.4 | 0 |
| Softened water | 9.2 | 6433 | 3548 | 920 | 1604 | <0.1 | <0.1 | 6467 | 17 | 1423 | 2264 | <0.0.4 | 0 |
| Electrolyzed water | 8.7 | <1 | 3602 | 157 | 1588 | <0.1 | <0.1 | 19 | 903 | 1487 | 2135 | 11309 | 205 |
| Catalytically | 8.6 | <1 | 3598 | 54 | 1340 | <0.1 | <0.1 | 78 | 916 | 1456 | 2134 | 11501 | 0.1 |
| decomposed water | | | | | | | | | | | | | |
| Product water | 7.1 | <1 | 36 | 0.5 | 11 | <0.1 | <0.1 | 7.3 | 3.3 | 26 | 22 | 44.9 | 0 |

<Table 2-2: Comparative Example 1>

| | | | | | | | | | | | | | |
|---|---|---|---|---|---|---|---|---|---|---|---|---|---|
| Water-to-be-treated | 6.7 | 6530 | 2731 | 1142 | 1931 | 101 | 272 | 6451 | 19 | 1429 | 2256 | <0.0.4 | 0 |
| Softened water | 9.2 | 6433 | 3548 | 920 | 1604 | <0.1 | <0.1 | 6467 | 17 | 1423 | 2264 | <0.0.4 | 0 |
| Electrolyzed water | 8.8 | <1 | 3589 | 160 | 1468 | <0.1 | <0.1 | 11 | 949 | 1511 | 2154 | 11761 | 230 |
| Catalytically | 8.8 | <1 | 3520 | 49 | 1350 | <0.1 | <0.1 | 78 | 959 | 1490 | 2106 | 11099 | 0.2 |
| decomposed water | | | | | | | | | | | | | |
| Product water | 7.2 | <1 | 48 | 0.5 | 9.4 | <0.1 | <0.1 | 8.5 | 4.8 | 26 | 28 | 54 | 0 |

TABLE 3

| | Power | Water |
|---|---|---|
| | consumption | recovery |
| | (W) | (%) |
| Example 1 | 368 | 85 |
| Example 2 | 404 | 85 |
| Comparative | 906 | 69 |
| example 1 | | |
| Comparative | 698 | 67 |
| example 2 | | |

The results obtained in Examples 1 and 2 and Comparative Examples 1 and 2 confirmed the following facts.

By the method according to the present invention which was employed in Examples 1 and 2, in which electrolysis was performed with the electrolysis apparatus under a high-temperature, high-pressure environment, the amount of free chlorine, chloric acid, and perchloric acid that place loads on the electrodialysis apparatus disposed downstream of the electrolysis apparatus was able to be reduced. In addition, since electrodialysis was performed in two different steps, the concentration of inorganic ions was able to be markedly reduced.

In particular, in Example 1, where water was treated by being passed through the high-temperature high-pressure electrolysis apparatus and the desalination electrodialysis apparatus in a once-through manner without being circulated inside these apparatuses, the qualities of the product water were better than in Example 2, where circulation was made. Furthermore, the amount of power consumed in Example 1 was smaller than in Example 2, while the degrees of water recovery achieved in Examples 1 and 2 were substantially equal to each other.

In Comparative Examples 1 and 2 where the method of the related art was employed, the TOC concentration in the product water was able to be reduced to an acceptable level, but the qualities of the product water were lower than in Examples 1 and 2. Markedly better results were obtained in Examples 1 and 2 than Comparative Examples 1 and 2 in terms of the amount of power consumed and the degree of water recovery. This confirmed that the method according to the present invention may be markedly advantageously employed in confined spaces such as structures in space.

### INDUSTRIAL APPLICABILITY

As described above, by the water recovery method and system according to the present invention, it is possible to remove impurities contained in domestic wastewater or water discharged by the human body by using a small, simple apparatus and reuse the treated water. The present invention may be particularly suitably applied to a life-support system for use in space stations.

Although the present invention has been described in detail with reference to particular embodiments, it is apparent to a person skilled in the art that various modifications can be made therein without departing from the spirit and scope of the present invention.

The present application is based on Japanese Patent Application No. 2013-221425 filed on Oct. 24, 2013, which is incorporated herein by reference in its entirety.

### REFERENCE SIGNS LIST

1 SOFTENING APPARATUS
2 HIGH-TEMPERATURE HIGH-PRESSURE ELECTROLYSIS APPARATUS
3 DESALINATION ELECTRODIALYSIS APPARATUS
4 ACID-ALKALI PRODUCTION ELECTRODIALYSIS APPARATUS
AM ANION-EXCHANGE MEMBRANE
CM CATION-EXCHANGE MEMBRANE
BPM BIPOLAR MEMBRANE

1. A water recovery method in which wastewater is treated and the resulting treated water is recovered as product water, the water recovery method comprising:
a softening step in which the wastewater is treated with a softening apparatus in order to remove a hardness component of the wastewater;
a high-temperature high-pressure electrolysis step in which softened water produced in the softening step is electrolyzed with a high-temperature high-pressure electrolysis apparatus, the electrolysis apparatus applying a direct current at a temperature equal to or higher than 100° C. and equal to or lower than a critical temperature of the softened water under a pressure at which the softened water is in a liquid phase in order to decompose an oxidizable substance contained in the softened water; and
a desalination electrodialysis step in which electrolyzed water produced in the high-temperature high-pressure electrolysis step is treated with an electrodialysis apparatus in order to produce product water and a salt-concentrated liquid, the product water including desalinated water being the electrolyzed water from which ions have been removed.

2. The water recovery method according to claim 1, wherein the wastewater is generated in a confined space.

3. The water recovery method according to claim 1, wherein the electrolyzed water is fed from the high-temperature high-pressure electrolysis step to the desalination electrodialysis step without any other water treatment step conducted therebetween.

4. The water recovery method according to claim 1, wherein, in the high-temperature high-pressure electrolysis step, electrolysis is performed with a high-temperature high-pressure electrolysis apparatus including a conductive diamond electrode in a high-temperature high-pressure environment of 200° C. or more and 5 MPa or more.

5. The water recovery method according to claim 1, wherein the high-temperature high-pressure electrolysis apparatus includes a cylindrical, tubular container and an anode, the anode being disposed inside the container so as to extend in a direction in which water-to-be-treated flows and to be insulated from the container, the container serving as a cathode in electrolysis.

6. The water recovery method according to claim 1, wherein the softened water is passed through the high-temperature high-pressure electrolysis apparatus in a once-through manner.

7. The water recovery method according to claim 1, wherein the high-temperature high-pressure electrolysis apparatus includes one or more reaction container groups arranged in parallel, the reaction container groups each being constituted by a plurality of reaction containers connected to one another in series.

8. The water recovery method according to claim 1, wherein the pressure inside the high-temperature high-pressure electrolysis apparatus is increased by controlling a high-pressure pump disposed on an entry side of the electrolysis apparatus, the high-pressure pump feeding water-to-be-treated to the electrolysis apparatus, and a back-pressure valve disposed on an exit side of the electrolysis apparatus.

9. The water recovery method according to claim 1, further comprising a heat exchanging step in which the softened water passed into the high-temperature high-pressure electrolysis apparatus is heated by exchanging heat between the softened water and the electrolyzed water in a high-pressure environment.

10. The water recovery method according to claim 1, further comprising an acid-alkali production electrodialysis step in which the salt-concentrated liquid produced in the desalination electrodialysis step is further treated with an electrodialysis apparatus in order to produce desalinated water, an acid solution, and an alkali solution; and a regeneration step in which the softening apparatus is regenerated by using the acid solution and the alkali solution produced in the acid-alkali production electrodialysis step.

11. The water recovery method according to claim 10, wherein part or the entirety of the desalinated water produced in the acid-alkali production electrodialysis step is treated in the desalination electrodialysis step together with the electrolyzed water.

12. A water recovery system in which wastewater is treated and the resulting treated water is recovered as product water, the water recovery system comprising:
a softening apparatus that removes a hardness component of the wastewater;
a high-temperature high-pressure electrolysis apparatus that electrolyzes softened water produced by the softening apparatus by applying a direct current at a temperature equal to or higher than 100° C. and equal to or lower than a critical temperature of the softened water under a pressure at which the softened water is in a liquid phase in order to decompose an oxidizable substance contained in the softened water; and
a desalination electrodialysis apparatus that treats electrolyzed water produced with the high-temperature high-pressure electrolysis apparatus in order to produce product water and a salt-concentrated liquid, the product water including desalinated water being the electrolyzed water from which ions have been removed.

13. The water recovery system according to claim 12, wherein the wastewater is generated in a confined space.

14. The water recovery system according to claim 12, wherein the electrolyzed water is fed from the high-temperature high-pressure electrolysis apparatus to the desalination electrodialysis apparatus without any other water treatment means interposed therebetween.

15. The water recovery system according to claim 12, wherein the high-temperature high-pressure electrolysis apparatus includes a conductive diamond electrode and performs electrolysis in a high-temperature high-pressure environment of 200° C. or more and 5 MPa or more.

16. The water recovery system according to claim 12, wherein the high-temperature high-pressure electrolysis apparatus includes a cylindrical, tubular container and an anode, the anode being disposed inside the container so as to extend in a direction in which water-to-be-treated flows and to be insulated from the container, the container serving as a cathode in electrolysis.

17. The water recovery system according to claim 12, wherein the softened water is passed through the high-temperature high-pressure electrolysis apparatus in a once-through manner.

18. The water recovery system according to claim 12, wherein the high-temperature high-pressure electrolysis apparatus includes one or more reaction container groups arranged in parallel, the reaction container groups each being constituted by a plurality of reaction containers connected to one another in series.

19. The water recovery system according to claim 12, wherein the pressure inside the high-temperature high-pressure electrolysis apparatus is increased by controlling a high-pressure pump disposed on an entry side of the electrolysis apparatus, the high-pressure pump feeding water-to-be-treated to the electrolysis apparatus, and a back-pressure valve disposed on an exit side of the electrolysis apparatus.

20. The water recovery system according to claim 12, further comprising a heat exchanger that heats the softened water passed into the high-temperature high-pressure electrolysis apparatus by exchanging heat between the softened water and the electrolyzed water in a high-pressure environment.

21. The water recovery system according to claim 12, further comprising an acid-alkali production electrodialysis apparatus that treats the salt-concentrated liquid produced by the desalination electrodialysis apparatus in order to produce desalinated water, an acid solution, and an alkali solution; and pipes through which the acid solution and the alkali solution produced with the acid-alkali production electrodialysis apparatus are each fed to the softening apparatus, the acid solution and the alkali solution being used for regenerating the softening apparatus.

22. The water recovery system according to claim 21, further comprising means for returning part or the entirety of the desalinated water produced by the acid-alkali production electrodialysis apparatus is returned to an entry side of the desalination electrodialysis apparatus.
